(19) United States
(12) Patent Application Publication
(10) Pub. No.: US 2019/0144715 A1
(43) Pub. Date: May 16, 2019

(54) ADHESIVE PRODUCT

(71) Applicant: MORESCO CORPORATION, Hyogo (JP)

(72) Inventors: Hiroki IWASE, Hyogo (JP); Yutaka NAGAI, Hyogo (JP)

(21) Appl. No.: 16/099,613

(22) PCT Filed: Mar. 8, 2017
(86) PCT No.: PCT/JP2017/009210

§ 371 Date: Nov. 7, 2018

(30) Foreign Application Priority Data
May 19, 2016 (JP) 2016-100555

(51) Int. Cl. C09J 7/20; C09J 201/02; C09J 7/35

(52) U.S. Cl. CPC C09J 7/201; C09J 2201/60; C09J 7/35; C09J 201/02

(57) ABSTRACT

An object of the present invention is to provide a thermoplastic adhesive product that can be automatically and continuously supplied to a hot melt tank and that can be produced easily. Provided is a thermoplastic adhesive product which is a long object in the form of a string or a sheet including a thermoplastic adhesive and which is rollable.

### TECHNICAL FIELD

The present invention relates to an adhesive product.

### BACKGROUND ART

Thermoplastic adhesives, which are heated to melt into liquid state prior to application, are in solid state at room temperature. Generally, thermoplastic adhesive products are provided in the form of blocks, and are heated to melt when used. However, such general thermoplastic adhesive products have an issue in that they may unite with each other because of heat or stress they have experienced during, for example, storage before use, and/or that a thermoplastic adhesive sticks to a packing container, and are therefore difficult to handle.

Some techniques have been proposed to address the above issue. Known examples of such techniques include (1) a method by which a thermoplastic adhesive, which has been heated to its flow temperature or above, is filled into a porous container coated with wax while cooling the container; and thereafter the container is cooled until the surface of the thermoplastic adhesive solidifies, and thereafter the thermoplastic adhesive is removed from the container by contacting the container with hot water having a temperature equal to or above the melting point of the wax (Patent Literature 1), (2) a method by which a thermoplastic adhesive composition is kneaded while heating at a temperature equal to or below a certain temperature in an extruder and is extruded from the extruder into a bar form, and the extruded composition is cut into particles (pellets) with cooling (Patent Literature 2), and (3) a method by which an adhesive product in liquid state and a non-adhesive protective coating material are co-extruded by a co-extrusion method and thereby the adhesive product coated with a non-adhesive protective coat is obtained (in other words, a thermoplastic adhesive product is obtained) (Patent Literature 3).

### CITATION LIST

### Patent Literature

### [Patent Literature 1]

Japanese Patent Application Publication, Tokukai, No. 2003-20467 (Publication Date: Jan. 24, 2003)

### [Patent Literature 2]

Japanese Patent Application Publication, Tokukai, No. 2000-256643 (Publication Date: Sep. 19, 2000)

### [Patent Literature 3]

Japanese Patent Application Publication, Tokukaihei, No. 11-348912 (Publication Date: Dec. 21, 1999)

### SUMMARY OF INVENTION

### Technical Problem

However, the above conventional thermoplastic adhesive products have an issue in that they cannot be easily supplied continuously to a hot melt tank provided to an applicator device when they are applied to an adherend.

For example, a thermoplastic adhesive product obtained by the method disclosed in Patent Literature 1 has issues in that (1) portions of the thermoplastic adhesives exposed from the porous containers may stick to each other when the thermoplastic adhesive products are packed and that (2) the thermoplastic adhesive product necessitates a troublesome process of separating the porous container and the thermoplastic adhesive from each other when the product is used. Thus, the thermoplastic adhesive product obtained by the method disclosed in Patent Literature 1 cannot easily be supplied continuously to a hot melt tank.

The technique disclosed in Patent Literature 2 has an issue in that, in a case where a highly adhesive thermoplastic adhesive is produced, the thermoplastic adhesive adheres to a cutter of a cutting unit of a granulator, and therefore this technique is not suitable for use in producing highly adhesive thermoplastic adhesives. In addition, the thermoplastic adhesive product in the technique disclosed in Patent Literature 2 has been cut into particles (pellets). Therefore, even in a case where such pellets of the thermoplastic adhesive product are supplied altogether to a hot melt tank, continuous supply, without intervals, of the pellets into the hot melt tank cannot be easily achieved.

The shape of the thermoplastic adhesive product disclosed in Patent Literature 3 is a so-called “pillow shape”. That is, each thermoplastic adhesive product in Patent Literature 3 is in a single pillow form. Therefore, as with the thermoplastic adhesive product disclosed in Patent Literature 2, it is not easy to continuously supply, without intervals, the thermoplastic adhesive product disclosed in Patent Literature 3 to a hot melt tank. In addition, the thermoplastic adhesive product disclosed in Patent Literature 3 has issues in that (1) it takes long time to cool and dry the thermoplastic adhesive product when producing the thermoplastic adhesive product because of the shape and thickness of the thermoplastic adhesive product and that (2) the quality of the thermoplastic adhesive product is unstable because aforementioned non-adhesive protective coat becomes uneven in thickness when the product is formed into a pillow shape.

As has been described, any of the conventional thermoplastic adhesive products, such as the thermoplastic adhesive products disclosed in Patent Literatures 1 to 3, cannot easily be supplied to a hot melt tank continuously. However, no progress has been made in development of an automated technique to introduce thermoplastic adhesive products into a hot melt tank. Thus, in existing techniques, the thermoplastic adhesive products require manual operation to be introduced into a hot melt tank.

As such, the conventional thermoplastic adhesive products require some improvement, from the viewpoint of work efficiency when using the adhesive products. In addition, first of all, production efficiency of conventional thermoplastic adhesive products, such as the thermoplastic adhesive product disclosed in Patent Literature 3, is far from satisfactory.

The present invention was made in view of the above issues, and an object thereof is to provide a thermoplastic adhesive product that can be automatically and continuously supplied to a hot melt tank provided to an applicator device and that can be produced easily, and a roll of the thermoplastic adhesive product.

### Solution to Problem

In order to attain the above object, the inventors have conducted diligent study on, for example, the relationship between the shape of a thermoplastic adhesive product and continuous supply of the product, and found that a thermoplastic adhesive product having a certain three-dimensional shape is capable of attaining the above object. On the basis of this finding, the inventors have accomplished the present invention. The inventors have also found that the thermoplastic adhesive product, which has certain physical properties, is capable of more efficiently attaining the above object.

Specifically, a thermoplastic adhesive product according to one or more embodiments of the present invention is a long object in the form of a string or a sheet and is rollable, the long object including a thermoplastic adhesive.

### Advantageous Effects of Invention

One or more embodiments of the present invention make it possible to avoid sticking between thermoplastic adhesives, and also make it possible to automatically and continuously introduce a thermoplastic adhesive product into a hot melt tank. As such, one or more embodiments of the present invention bring about an effect of making it possible to dramatically improve handleability of the thermoplastic adhesive product and work efficiency when using the thermoplastic adhesive product.

### BRIEF DESCRIPTION OF DRAWINGS

FIG. 1 shows the appearance of a roll of a string-form thermoplastic adhesive product produced in an Example.

FIG. 2 schematically illustrates one example of the shape of a thermoplastic adhesive product according to one or more embodiments of the present invention, and shows one example of the appearance of a long object in the form of a string.

FIG. 3 schematically illustrates one example of the shape of a thermoplastic adhesive product according to one or more embodiments of the present invention, and shows how the thermoplastic adhesive product in the form of a sheet is rolled up.

FIG. 4 shows the appearance of a pillow-shape thermoplastic adhesive product of a Comparative Example.

FIG. 5 shows the appearance of a block-shape thermoplastic adhesive product of a Comparative Example whose surface has been treated to be easily releasable (or detachable).

FIG. 6 shows the appearance of a block-shape thermoplastic adhesive product of a Comparative Example.

### DESCRIPTION OF EMBODIMENTS

The following description will discuss one or more embodiments of the present invention. Note, however, that the present invention is not limited to the following embodiments, but can be altered by a skilled person in the art within the scope of the claims. The present invention also encompasses, in its technical scope, any embodiment or example derived by combining technical means disclosed in differing embodiments and/or examples. All academic and patent literatures listed herein are incorporated herein by reference. Note that the expression “A to B”, representing a numeric range, herein means “not less than A and not more than B” unless otherwise specified in this specification.

[1. Thermoplastic Adhesive Product]

A thermoplastic adhesive product according to one or more embodiments of the present invention is a long object in the form of a string or a sheet and is rollable. The long object includes a thermoplastic adhesive.

The thermoplastic adhesive for use in one or more embodiments of the present invention is obtained by adding, depending on need, some additive(s) such as a tackifier resin and/or waxes to a thermoplastic resin. The thermoplastic adhesive for use in one or more embodiments of the present invention can be a known thermoplastic adhesive. The thermoplastic resin is not limited to a particular kind. Examples of the thermoplastic resin include ethylene-vinyl acetate copolymers, ethylene-acrylate copolymers, atactic polypropylene, and amorphous poly(α-olefin), which are in liquid state at a temperature of 50° C. to 200° C. These thermoplastic resins may be used independently or two or more of them may be used in combination.

Examples of the tackifier resin include: natural resins such as those available under the trade names such as gum rosin, wood rosin, and tall oil rosin; modified rosins such as rosin polymers and partially hydrogenated rosins; derivatives of rosins and of modified rosins, i.e., glycerol ester rosins (including partially hydrogenated versions of the glycerol ester rosins, completely hydrogenated versions of the glycerol ester rosins, and polymers of the glycerol ester rosins) and pentaerythritol esters (including partially hydrogenated versions of the pentaerythritol esters, completely hydrogenated versions of the pentaerythritol esters, and polymers of the pentaerythritol esters); polyterpene-based resins such as polymers of α-pinene, polymers of β-pinene, and dipentene polymers; modified terpenes such as terpene-phenol copolymers and α-pinene-phenol copolymers; aliphatic petroleum resins; alicyclic petroleum resins; cyclopentadiene resins; aromatic petroleum resins; phenolic resins; alkyl phenol-acetylene-based resins; styrene-based resins; xylene-based resins; coumarone-indene resins; vinyltoluene; and α-methylstyrene copolymers.

Examples of the waxes include carnauba wax, montan wax, paraffin wax, and microcrystalline wax. Among these, it is particularly preferable to use waxes at least one of which is a paraffin-based wax or a Fischer-Tropsch wax that contains 85 wt. % or more n-paraffin component.

The thermoplastic adhesive may contain some additive(s) depending on need, such as an antioxidant, an ultraviolet absorber, filler, and/or a colorant.

An example of a typical synthetic-rubber-based thermoplastic adhesive is a thermoplastic adhesive that contains a synthetic rubber, a tackifier, an olefin-based resin, and an additive(s) (the total of these constituents is 80 wt. % to 95 wt. %) and a lubricant base oil (5 wt. % to 20 wt. %) such that the total is 100 wt. %.

A method of producing the thermoplastic adhesive is not particularly limited, and may be, for example, a method by which the above-mentioned materials are mixed together by kneading with heat with the use of an apparatus(es) such as a melt bath, a roll, a Banbury mixer, a kneader, and/or an extruder. Needless to say, these apparatuses may be commercially-available apparatuses.

The term “long object” herein refers to a three-dimensional structure that has opposite ends and an intermediate portion. The term “long object in the form of a string” refers to any long object in which the length of the intermediate portion is greater than the inner diameter of a cross section perpendicular to the lengthwise direction of the long object. The shape of the cross section is not particularly limited, but is preferably substantially circular or substantially oval because such a long object is easily rollable and is capable of being uniformly coated. The long object in the form of a string may also be referred to as a long object in the form of a rope.

The term “inner diameter” refers to the diameter of a circle inscribed in a cross section (two-dimensional shape) perpendicular to the lengthwise direction of the long object. For example, in a case where the cross section is in the shape of a circle, the “inner diameter” refers to the diameter of the circle, whereas, in a case where the cross section is in the shape of an oval, the “inner diameter” refers to the length of the minor axis of the oval.

FIG. 2 schematically illustrates one example of the shape of a thermoplastic adhesive product according to one or more embodiments of the present invention, and shows one example of the appearance of a long object in the form of a string. In FIG. 2, the reference number “10” indicates the thermoplastic adhesive product in the form of a string, the reference number “1” indicates a core part constituted by a thermoplastic adhesive, the reference number “2” indicates a non-adhesive material, the reference number “3” indicates one of opposite ends (hereinafter referred to as one end) of the thermoplastic adhesive product 10, the reference number “4” indicates the other of the opposite ends (hereinafter referred to as the other end) of the thermoplastic adhesive product 10, and the reference number “5” indicates an intermediate portion of the thermoplastic adhesive product 10.

As illustrated in FIG. 2, when the thermoplastic adhesive product 10 is cut along plane Z-Z perpendicular to the lengthwise direction of the long object, the length (i.e., the dimension in the lengthwise direction) of the intermediate portion 5 between the one end 3 and the other end 4 is greater than the inner diameter of the cross section. Note that the inner diameter in FIG. 2 refers to the diameter of a circle inscribed in the outer circumference of the non-adhesive material 2.

FIG. 2 illustrates one example of the shape of the thermoplastic adhesive product 10 in which the thermoplastic adhesive constitutes the core part 1 of the thermoplastic adhesive product 10 and the surface of the core part 1 is partially or entirely coated with the non-adhesive material 2. Note, however, that the shape illustrated in FIG. 2 is merely an example. The non-adhesive material is not essential to the thermoplastic adhesive product according to one or more embodiments of the present invention.

The non-adhesive material 2 is used to form a protective coat to protect the core part 1. Note, however, that the thermoplastic adhesive product 10, even without the non-adhesive material 2, can be continuously supplied to a hot melt tank or the like without problems, provided that, for example, even if adjacent faces of the intermediate portion 5 are brought into contact with each other when the thermoplastic adhesive product 10 is rolled or bent, the adjacent faces of the intermediate portion 5 can be detached from each other. As such, such a thermoplastic adhesive product 10 with no non-adhesive material 2 is capable of attaining the object of the present invention.

As described above, the non-adhesive material is not essential to the thermoplastic adhesive product according to one or more embodiments of the present invention. Note that, in a case where the thermoplastic adhesive product 10 includes no non-adhesive material 2, the inner diameter in FIG. 2 refers to the diameter of a circle inscribed in the outer circumference of the core part 1.

Assume that the thermoplastic adhesive product according to one or more embodiments of the present invention is configured such that, as illustrated in FIG. 2, the thermoplastic adhesive constitutes the core part of the thermoplastic adhesive product and the surface of the core part is partially or entirely coated with the non-adhesive material. In this case, even in a case where the core part 1 is constituted by a highly adhesive thermoplastic adhesive, adjacent faces of the intermediate portion 5 do not stick to each other even if the faces are brought into contact with each other when the thermoplastic adhesive product 10 is rolled or bent. As such, the embodiment illustrated in FIG. 2 is suitable when a highly adhesive thermoplastic adhesive is used.

The non-adhesive material is used to partially or entirely coat the surface of the core part constituted by the thermoplastic adhesive and to form a protective coat to protect the thermoplastic adhesive. The non-adhesive material may be chemically neutral to the thermoplastic adhesive. Alternatively, the protective coat can be chemically compatible with the thermoplastic adhesive. The protective coat can be constituted by a material that is not adhesive to substances outside the protective coat and that is reactive with the thermoplastic adhesive at the boundary between the protective coat and the thermoplastic adhesive (core part).

In any case, it is preferable that there is no need to remove the protective coat from the thermoplastic adhesive and that the protective coat can be processed together with the thermoplastic adhesive during the subsequent use of the thermoplastic adhesive product according to one or more embodiments of the present invention. For example, the thermoplastic adhesive product according to one or more embodiments of the present invention is preferably configured such that: the thermoplastic adhesive product, whose core part's surface is partially or entirely coated with the non-adhesive material, is introduced into a hot melt tank and thereby the non-adhesive material is allowed to melt.

In a case where the thermoplastic adhesive product includes the non-adhesive material, the amount of the non-adhesive material is preferably 0.5 wt. % to 5 wt. %, more preferably 1 wt. % to 1.5 wt. %, relative to the weight of the thermoplastic adhesive product. The amount of the non-adhesive material is preferably 0.5 vol. % to 5 vol. %, more preferably 1 vol. % to 1.5 vol. %, relative to the volume of the thermoplastic adhesive (core part).

An example of a typical non-adhesive material is a non-adhesive material that contains an olefin-based copolymer (64 wt. % to 74 wt. %), an ethylene-vinyl acetate copolymer (23 wt. % to 33 wt. %), and an additive(s) (not more than 7 wt. %) such that the total is 100 wt. %.

A method of producing the non-adhesive material is not particularly limited, and may be, for example, a method by which the above-mentioned materials are mixed together by kneading with heat with the use of an apparatus(s) such as a melt bath, a roll, a Banbury mixer, a kneader, and/or an extruder. Needless to say, these apparatuses may be commercially-available apparatuses.

The expression “the surface of the core part is partially coated with the non-adhesive material” means that the surface of the thermoplastic adhesive product does not need to be coated entirely, provided that the thermoplastic adhesive product with the non-adhesive material satisfies all the following conditions (1) to (3): (1) the thermoplastic adhesive product is a long object in the form of a string or a sheet; (2) the thermoplastic adhesive product has a shape that is rollable; and (3) adjacent faces of the core part do not stick to each other.

On one hand, in a case where a highly adhesive thermoplastic adhesive is used, it is more preferable that a larger proportion of the surface area of the core part in the lengthwise direction of the long object is coated with the non-adhesive material. This makes it possible to more unfailingly prevent adjacent faces of the core part from sticking to each other when the long object is rolled, bent, or the like. The above proportion is preferably not less than 80%, more preferably not less than 90%, even more preferably not less than 95%, most preferably 100%.

On the other hand, usually, one end and the other end of the long object are less likely to make contact with the surface in the lengthwise direction of the long object even when the long object is rolled, bent, or the like, as compared to other portions of the surface of the core part. Therefore, the one end and the other end may be or may not be coated with the non-adhesive material.

The term “long object in the form of a sheet” refers to a long object whose cross section perpendicular to the lengthwise direction of the long object is a rectangle in shape and the length of the intermediate portion is greater than each of the long and short sides of the rectangle.

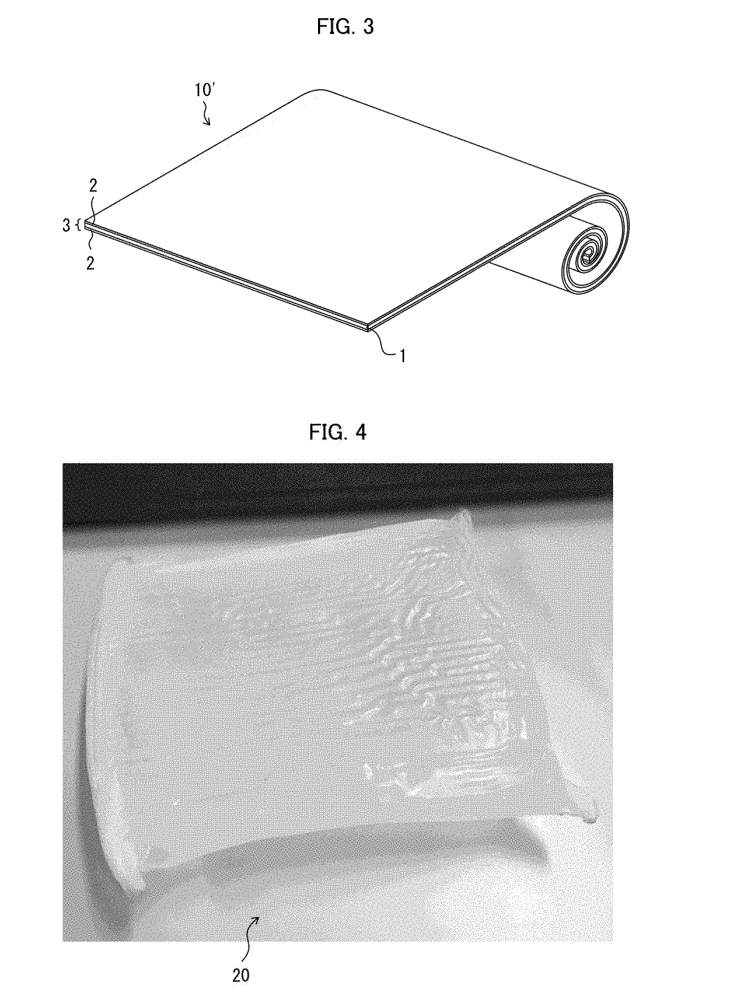

FIG. 3 schematically illustrates one example of the shape of a thermoplastic adhesive product according to one or more embodiments of the present invention, and shows how a thermoplastic adhesive product in the form of a sheet is rolled up. In FIG. 3, the reference number “10′” indicates the thermoplastic adhesive product, and the reference numbers “1” to “3” are as defined in FIG. 2. The thermoplastic adhesive product 10′ in the form of a sheet is such that the length (dimension in the lengthwise direction of the thermoplastic adhesive product 10′) of the intermediate portion is much greater than the length of the long side of a rectangular cross section at one end 3 (this length is a dimension in the widthwise direction of the thermoplastic adhesive product 10′) and the length of the short side of the rectangular cross section (this length is the thickness of the thermoplastic adhesive product 10′). Note that a non-adhesive material 2 is not essential to the thermoplastic adhesive product 10′, as with the case of the thermoplastic adhesive product 10.

The foregoing thermoplastic adhesive product in the form of a string and the above thermoplastic adhesive product in the form of a sheet are both rollable. That is, a thermoplastic adhesive product according to one or more embodiments of the present invention is a long object that is in the form of a string or a sheet and also has flexibility, and therefore is capable of being rolled. The term “roll” can either mean that the thermoplastic adhesive product is wrapped around a core to form a roll or that the thermoplastic adhesive product is coiled into a roll without a core as illustrated in FIG. 3. Since the thermoplastic adhesive product is configured to be rollable, the scope of the thermoplastic adhesive product in accordance with the present invention does not include thermoplastic adhesive products that are not capable of being rolled, for example, those which are too short to be rolled or those which are too rigid to be rolled.

Meanwhile, the thermoplastic adhesive product according to one or more embodiments of the present invention is not necessarily actually rolled, provided that the thermoplastic adhesive product is rollable. For example, according to one or more embodiments of the present invention, the following configuration may be employed: about 20 kg to 1 t of a thermoplastic adhesive product in the form of a string is packed in a container without being rolled. Alternatively, the following configuration may be employed: a thermoplastic adhesive product in the form of a sheet is folded and packed in a container. Such thermoplastic adhesive products can also be continuously sent into a hot melt tank.

The length of the long object is preferably not less than 1 m. When the length of the long object is not less than 1 m, the amount of the thermoplastic adhesive product automatically introduced into a hot melt tank is increased and also work efficiency improves.

The upper limit of the length of the long object is not limited in any way, provided that the long object is rollable. A long object having a longer length is more preferred. Increasing the length of the long object without an upper limit is technically possible. In practical use, the upper limit of the length of the long object is preferably, for example, 100 m to 1000 m, in order to achieve easy handling and the like. Note, however, that the upper limit of the length of the long object is not limited as such, as described earlier.

The weight of the long object is preferably not less than 10 kg. In existing techniques, thermoplastic adhesive products are introduced into a hot melt tank manually, and therefore it is not realistic to introduce 10 kg or more thermoplastic adhesive product into a hot melt tank at one time. In contrast, the thermoplastic adhesive product according to one or more embodiments of the present invention has the foregoing shape, and therefore can be continuously and automatically introduced into a hot melt tank in an amount much more than that manually introduced into the tank.

The upper limit of the weight of the long object is not particularly limited, and may be selected according to the length of the long object.

The inner diameter of a cross section perpendicular to the lengthwise direction of the long object is preferably 5 mm to 300 mm, more preferably 5 mm to 100 mm, even more preferably 5 mm to 50 mm, most preferably 5 mm to 15 mm, for faster production and shorter time for the long object to be cooled in the production process.

The thermoplastic adhesive product according to one or more embodiments of the present invention preferably has a storage modulus of not more than 5.0×10⁶ Pa and an elongation at break of not less than 200%, more preferably has a storage modulus of not more than 1.0×10⁶ Pa and an elongation at break of not less than 400%, particularly preferably has a storage modulus of not more than 7.0×10⁴ Pa and an elongation at break of not less than 2000%, for the thermoplastic adhesive product to be flexible enough to be easily rolled.

A thermoplastic adhesive product having the above properties (the above levels of storage modulus and elongation at break) can be obtained by appropriately selecting the compositions of the thermoplastic resin, additive(s), and the like which constitute the thermoplastic adhesive. Alternatively, a commercially-available thermoplastic adhesive having appropriate levels of storage modulus and elongation at break can be used to prepare a thermoplastic adhesive product that has equivalent properties.

The storage modulus is determined based on dynamic viscoelasticity measured under the following conditions. Specifically, the dynamic viscoelasticity is measured at 5° C. with a frequency of 1 Hz with the use of an elastic modulus measurer (ARES rheometer available from TA Instruments) using an 8 φ flat plate. On the basis of the obtained dynamic viscoelasticity, the storage modulus is determined by the above instrument.

The elongation at break is specified in JIS K6251 (2010), and can be determined by a method in accordance with JIS K6251 (2010). In Examples (describe later), the elongation at break of a thermoplastic adhesive product, which had been processed into the form of a string, was measured under the conditions in which tension speed was 100 mm/min., length of test piece was 20 mm, and temperature was 23° C., with the use of a tensile tester measurer (Autograph AGS-X 500N available from Shimadzu corporation).

The thermoplastic adhesive product according to one or more embodiments of the present invention preferably has a viscosity of 1000 mPa·S to 100,000 mPa·S at 130° C. The temperature “130° C.” refers to the temperature of the thermoplastic adhesive product. The viscosity can be measured with the use of a known viscometer.

[2. Production of Thermoplastic Adhesive Product]

A method of producing a thermoplastic adhesive product according to one or more embodiments of the present invention is not limited in any way to a particular method. For example, the shape of a thermoplastic adhesive product can be controlled, that is, a thermoplastic adhesive product in the form of a string can be produced, by appropriately controlling conditions such as the following conditions (1) to (4): (1) physical properties (e.g., viscosity, temperature, and/or the like) of the thermoplastic adhesive in liquid form; (2) the amount of extrusion of a product from an extruder (e.g., co-extruder); (3) extrusion rate (rate of extrusion); and (4) conditions in which the extruded product is cooled.

In one or more embodiments of the present invention, it is also possible to produce a thermoplastic adhesive product which is a long object in the form of a sheet, by rolling out the extruded product with the use of, for example, a roller immediately after extrusion from the extruder and while the extruded product is flowable (in other words, before the extruded product solidifies).

[3. Roll]

A roll according to one or more embodiments of the present invention is a roll of a thermoplastic adhesive product according to one or more embodiments of the present invention. As described earlier, the thermoplastic adhesive product according to one or more embodiments of the present invention is a long object in the form of a string or a sheet, and therefore is flexible to a suitable degree and can be coiled into a roll or wrapped around something to form a roll.

The thermoplastic adhesive product can be coiled into a roll or wrapped around something to form a roll by a known method. For example, the thermoplastic adhesive product can be wound around a core with the use of a known winder or can be rolled up into a roll. A suitable example of the winder is a bobbin winder or the like, which is capable of winding a to-be-wound object onto a bobbin or the like while measuring the length of the to-be-wound object.

The roll does not have any other cut surfaces other than its opposite ends, unlike thermoplastic adhesive products in the form of pillows, particles (pellets), and blocks. It is therefore possible to continuously and automatically introduce the thermoplastic adhesive product into a hot melt tank or the like in a production line by unrolling and letting out the thermoplastic adhesive product by a user of the thermoplastic adhesive product.

The above configuration achieves the following. For example, in plants, factories, or the like in the paper or wood-related fields dealing with a huge quantity of thermoplastic adhesive product, it is possible to reduce the number of people who introduce the thermoplastic adhesive product into a tank or the like, reduce the number of processes, and the like, and thus possible to dramatically improve work efficiency. It is also possible to avoid troubles such as stoppage of the production line which would result from a reduced amount of the thermoplastic adhesive product in a hot melt tank, and thus possible to eliminate the need for troublesome process control and contribute to efficient and safe production.

One or more embodiments of the present invention are not limited to the foregoing embodiments, but can be altered by a skilled person in the art within the scope of the claims. The present invention also encompasses, in its technical scope, any embodiment derived by combining technical means disclosed in differing embodiments.

A thermoplastic adhesive product according to one or more embodiments of the present invention is a long object in the form of a string or a sheet and is rollable, the long object including a thermoplastic adhesive.

According to the above configuration, even when one face of the thermoplastic adhesive is brought into contact with the other face of the thermoplastic adhesive at room temperature at which the thermoplastic adhesive is in solid state, the one and the other faces of the thermoplastic adhesive are prevented from sticking to each other, provided that the thermoplastic adhesive is adhesive only to a degree that allows the one and the other faces of the thermoplastic adhesive to be detached from each other. The thermoplastic adhesive product according to one or more embodiments of the present invention configured as described above is a long object in the form of a string or a sheet and is rollable. Such a thermoplastic adhesive product, when, for example, wrapped around a core to form a roll or coiled into a roll, is capable of being continuously and automatically introduced into a hot melt tank or the like without intervals.

This makes it possible to dramatically improve handleability of the thermoplastic adhesive product and work efficiency when using the thermoplastic adhesive product.

The thermoplastic adhesive product according to one or more embodiments of the present invention is in the form of a string or a sheet, unlike many of the known thermoplastic adhesive products in the form of blocks. Such a thermoplastic adhesive product in the form of a string or a sheet can be efficiently cooled and dried. This also makes it possible to easily produce thermoplastic adhesive products and to reduce the size of production equipment and save energy.

Furthermore, the thermoplastic adhesive product according to one or more embodiments of the present invention, which is in the form of a string or a sheet, is substantially uniform in shape. Such a thermoplastic adhesive product has a simple shape with a small number of end faces, and also is a long object. Therefore, the thermoplastic adhesive product according to one or more embodiments of the present invention does not necessitate observations from different directions and can be observed in a continuous manner, during inspection. This facilitates the inspection and even makes it possible to automate the inspection process for the thermoplastic adhesive product.

The thermoplastic adhesive product according to one or more embodiments of the present invention is preferably configured such that the thermoplastic adhesive constitutes a core part of the thermoplastic adhesive product, the core part having a surface thereof partially or entirely coated with a non-adhesive material.

According to the above configuration, the surface of the core part is partially or entirely coated with the non-adhesive material. This makes it possible to more unfailingly prevent faces of the thermoplastic adhesive from sticking to each other.

This makes it possible to further improve handleability of the thermoplastic adhesive product and work efficiency when using the thermoplastic adhesive product.

The thermoplastic adhesive product according to one or more embodiments of the present invention is preferably configured such that the thermoplastic adhesive product has a cross section whose inner diameter is 5 mm to 300 mm, the cross section being perpendicular to a lengthwise direction of the long object.

According to the above configuration, due to the above inner diameter, it is possible to reduce the time for the long object to be cooled in a production process. This contributes to a further improvement of work efficiency and also makes it possible to reduce the size of a cooling device.

The thermoplastic adhesive product according to one or more embodiments of the present invention is preferably configured such that the thermoplastic adhesive product has a storage modulus of not more than 5.0×10⁶ Pa and an elongation at break of not less than 200%.

According to the above configuration, the thermoplastic adhesive product is flexible enough and do not develop product damage such as tearing or cracking even when subjected to physical deformation such as rolling. This makes it possible to more easily roll and unroll the thermoplastic adhesive product. It is therefore possible to more efficiently introduce the thermoplastic adhesive product into a tank or the like continuously and more efficiently produce the roll.

A roll according to one or more embodiments of the present invention is a roll of a thermoplastic adhesive product according to one or more embodiments of the present invention.

According to the above configuration, the roll does not have any other cut surfaces other than its opposite ends, unlike thermoplastic adhesive products in the form of blocks, pillows, and particles (pellets). Therefore, the thermoplastic adhesive product can be unrolled from the roll and continuously sent to a hot melt tank. This makes it possible to automate the introduction of the thermoplastic adhesive product into the hot melt tank, which has been carried out manually, and makes it possible to carry out the introduction continuously.

This makes it possible to dramatically improve handleability of the thermoplastic adhesive product and work efficiency when using the thermoplastic adhesive product. Since the amount of time that the thermoplastic adhesive product is exposed to air is reduced, the roll is also expected to have the effect of preventing oxidation of the thermoplastic adhesive product.

### EXAMPLES

The following description will discuss one or more embodiments of the present invention in more detail, on the basis of Examples. Note, however, that one or more embodiments of the present invention are not limited to the following Examples.

### Example 1

A synthetic-rubber-based thermoplastic adhesive (TN286-Z available from MORESCO Corporation) was used as a thermoplastic adhesive. An olefin-based thermoplastic adhesive (PROTECTOR B available from MORESCO Corporation) was used as a non-adhesive material.

The synthetic-rubber-based thermoplastic adhesive and the olefin-based thermoplastic adhesive, which were raw materials, were introduced into a co-extruder (Co-Extrusion Machine S1000 available from JPB Industry) such that the volume ratio of the olefin-based thermoplastic adhesive to the synthetic-rubber-based thermoplastic adhesive was 1%. The co-extruder was configured so that the rate of extrusion would be 50 kg/h, temperature of cooling water would be 7° C., cooling time would be 10 minutes, and temperature of extruded product (the temperature immediately after extrusion from the co-extruder) would be 130° C., and co-extrusion was carried out so that the inner diameter of a cross section perpendicular to the lengthwise direction of the extruded product would be 5 mm to 25 mm. The discharge hole (nozzle) used here was a discharge hole having a diameter of 30 mm.

The co-extrusion was carried out under the above conditions, and the extruded product in the form of a string was obtained. The extrusion was carried out without using a cutting mechanism of the co-extruder, and therefore the start of the extrusion resulted in one of the opposite ends of the extruded product and the completion of the extrusion (i.e., all the materials were extruded from the co-extruder) resulted in the other of the opposite ends of the extruded product.

The extruded product, immediately after discharged from the co-extruder, was placed into a cooling water pool and allowed to stay in the cooling water pool, and thereby was cooled. After the earlier-mentioned cooling time had passed, the extruded product was dried under the conditions in which air discharge pressure was not less than 5 kPa, air velocity was not less than 10 NL/min, air temperature was 15° C. to 25° C., and the like, to obtain a thermoplastic adhesive product 10a in the form of a string. The inner diameter of a cross section perpendicular to the lengthwise direction of the thermoplastic adhesive product 10a was 8 mm.

The thermoplastic adhesive product 10a was found to have a storage modulus of 1.0×10⁶ Pa and an elongation at break of 2000%. The storage modulus and the elongation at break are indicators of flexibility. It was also confirmed that the thermoplastic adhesive product 10a has, at about an elongation at break of 1000%, a breakage peak that is characteristic of the non-adhesive material.

The storage modulus was determined in the following manner. Specifically, dynamic viscoelasticity was measured at 5° C. with a frequency of 1 Hz with the use of an elastic modulus measurer (ARES rheometer available from TA Instruments) using an 8 φ flat plate. On the basis of the obtained dynamic viscoelasticity, the storage modulus was determined by the above instrument.

The elongation at break of the thermoplastic adhesive product, which had been processed into the form of a string, was measured under the conditions in which tension speed was 100 mm/min., length of test piece was 20 mm, and temperature was 23° C., with the use of a tensile tester measurer (Autograph AGS-X 500N available from Shimadzu Corporation).

### Example 1a

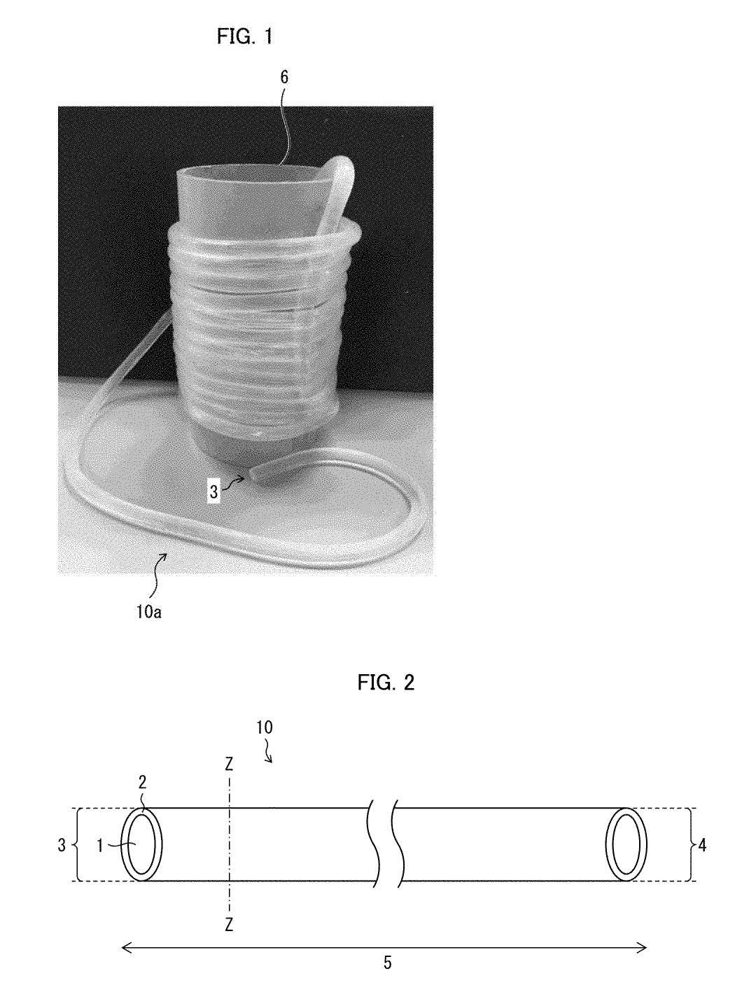

The thermoplastic adhesive product 10a was wrapped around a core to form a roll. FIG. 1 shows the appearance of the roll of the string-form thermoplastic adhesive product 10a produced in Example 1a. In FIG. 1, the reference number “3” indicates one of the opposite ends (hereinafter referred to as one end) of the thermoplastic adhesive product 10a, and the reference number “6” indicates the core. The thermoplastic adhesive product 10a is a long object in the form of a string whose intermediate portion (the portion other than the opposite ends of the thermoplastic adhesive product 10a, i.e., the portion extending in the lengthwise direction) is coated with the non-adhesive material. Even when the thermoplastic adhesive product 10a was wrapped around the core 6, no adhesion was found between any adjacent faces of the intermediate portion. The thermoplastic adhesive product 10a was long and flexible enough to be easily formed into a roll as illustrated in FIG. 1.

### Example 2

The same operations as described in Example 1 were carried out, except that the rate of extrusion was changed to 200 kg/h, to obtain a thermoplastic adhesive product in the form of a string. The obtained thermoplastic adhesive product was used as a thermoplastic adhesive product 10b. The inner diameter of the thermoplastic adhesive product 10b was found to be 14 mm. The thermoplastic adhesive product 10b was subjected to the same measurement methods as described in Example 1, and was found to have a storage modulus of 1.0×10⁶ Pa and an elongation at break of 2000%. The storage modulus and the elongation at break are indicators of flexibility. It was also confirmed that the thermoplastic adhesive product 10b has, at about an elongation at break of 1000%, a breakage peak resulting from the non-adhesive material.

### Example 2a

The thermoplastic adhesive product 10b was wrapped around a core to form a roll. As with the thermoplastic adhesive product 10a, the thermoplastic adhesive product 10b was also easily formed into a roll. Even when the thermoplastic adhesive product 10b was wrapped around the core, no adhesion was found between any adjacent faces of the intermediate portion.

### Example 3

The same operations as described in Example 1 were carried out, except that the rate of extrusion was changed to 400 kg/h, to obtain a thermoplastic adhesive product in the form of a string. The obtained thermoplastic adhesive product was used as a thermoplastic adhesive product 10c. The inner diameter of the thermoplastic adhesive product 10c was found to be 25 mm. The thermoplastic adhesive product 10c was subjected to the same measurement methods as described in Example 1, and was found to have a storage modulus of 1.0×10⁶ Pa and an elongation at break of 2000%. The storage modulus and the elongation at break are indicators of flexibility. It was also confirmed that the thermoplastic adhesive product 10c has, at about an elongation at break of 1000%, a breakage peak resulting from the non-adhesive material.

### Example 3a

The thermoplastic adhesive product 10c was wrapped around a core to form a roll. As with the thermoplastic adhesive product 10a, the thermoplastic adhesive product 10c was also easily formed into a roll. Even when the thermoplastic adhesive product 10c was wrapped around the core, no adhesion was found between any adjacent faces of the intermediate portion.

### Comparative Example

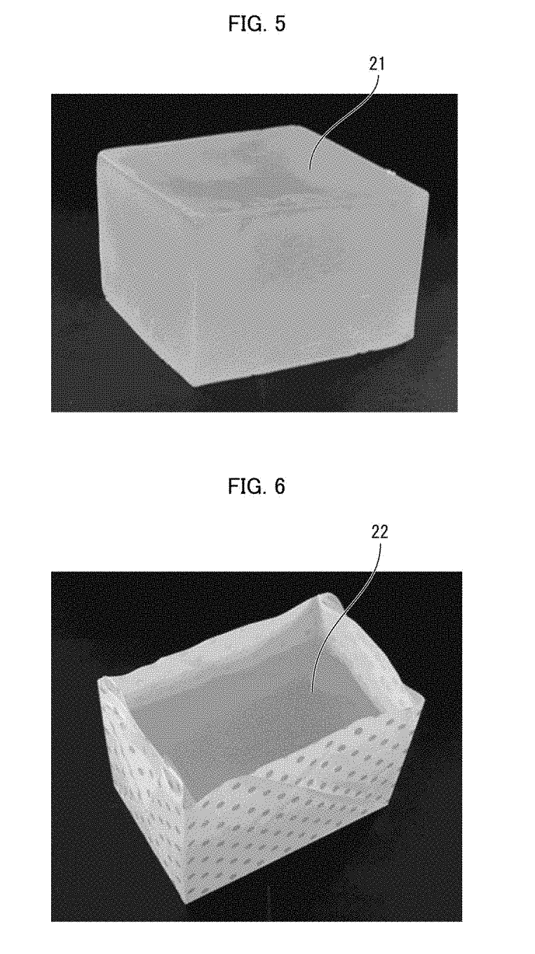

FIG. 4 shows the appearance of a pillow-shape thermoplastic adhesive product 20 (RAC-20Z available from MORESCO Corporation: 110 mm×130 mm×60 mm, about 350 g). FIG. 5 shows the appearance of a block-shape thermoplastic adhesive product 21 whose surface has been treated to be easily releasable (or detachable) (TN-289 available from MORESCO Corporation: 150 mm×150 mm×100 mm, about 2.5 kg). FIG. 6 shows the appearance of a block-shape thermoplastic adhesive product 22 (AS-92 available from MORESCO Corporation: 90 mm×140 mm×85 mm, about 1 kg).

Each of the thermoplastic adhesive products 20 to 22 is in a separate and independent form as illustrated in FIGS. 4 to 6, and is not provided in a continuous series. Such thermoplastic adhesive products 20 to 22 cannot be continuously supplied to a hot melt tank, unlike the thermoplastic adhesive products 10a to 10c produced in Examples 1 to 3. As such, the thermoplastic adhesive products 20 to 22 require manual operation to be supplied to a hot melt tank, as carried out in existing techniques.

Furthermore, the thermoplastic adhesive products 20 to 22 have a larger number of end faces, and therefore require more time to be cooled during production. The thermoplastic adhesive products 20 to 22 therefore require more time to be produced than the thermoplastic adhesive products 10a to 10c, which have a simple shape with a smaller number of end faces. In addition, the thermoplastic adhesive products 20 to 22 have an issue in that the temperature range suitable for both cutting and shape retention differs among products and this necessitates precise control of the condition setting of the co-extruder when changing the kinds of product to produce. In contrast, the thermoplastic adhesive products 10a to 10c do not involve such an issue and can be easily produced, because the thermoplastic adhesive products 10a to 10c do not have to be cut.

As is clear from above, the thermoplastic adhesive products 10a to 10c are advantageous in that they can be continuously supplied to a hot melt tank and that they can be produced with good efficiency.

### INDUSTRIAL APPLICABILITY

The present invention is suitably applicable in the fields dealing with a huge quantity of thermoplastic adhesive product, for example, in paper or wood-related fields.

### REFERENCE SIGNS LIST

1 . . . Core part constituted by thermoplastic adhesive
2 . . . Non-adhesive material
3 . . . One end of thermoplastic adhesive product
4 . . . Other end of thermoplastic adhesive product
5 . . . Intermediate portion of thermoplastic adhesive product
6 . . . Core
10 . . . Thermoplastic adhesive product in the form of a string
10′ . . . Thermoplastic adhesive product in the form of a sheet
10a . . . Thermoplastic adhesive product produced in Example 1
10b . . . Thermoplastic adhesive product produced in Example 2
10c . . . Thermoplastic adhesive product produced in Example 3
20 . . . Pillow-shape thermoplastic adhesive product
21 . . . Block-shape thermoplastic adhesive product whose surface has been treated to be easily releasable (or detachable)
22 . . . Block-shape thermoplastic adhesive product

1. A thermoplastic adhesive product which is a long object in the form of a string or a sheet and which is rollable, the long object comprising a thermoplastic adhesive.

2. The thermoplastic adhesive product according to claim 1, wherein the thermoplastic adhesive constitutes a core part of the thermoplastic adhesive product, the core part having a surface thereof partially or entirely coated with a non-adhesive material.

3. The thermoplastic adhesive product according to claim 1, wherein the thermoplastic adhesive product has a cross section whose inner diameter is 5 mm to 300 mm, the cross section being perpendicular to a lengthwise direction of the long object.

4. The thermoplastic adhesive product according to claim 1, wherein the thermoplastic adhesive product has a storage modulus of not more than 5.0×106 Pa and an elongation at break of not less than 200%.

5. A roll of the thermoplastic adhesive product recited in claim 1.
